(19) United States
(12) Patent Application Publication
(10) Pub. No.: US 2022/0341241 A1
(43) Pub. Date: Oct. 27, 2022

(54) DEVICE AND METHOD FOR IDENTIFYING AND MONITORING THE STATE OF AN ARRANGEMENT TO BE MONITORED HAVING AN OPENABLE AND CLOSEABLE WING ELEMENT

(71) Applicant: SCHÜCO INTERNATIONAL KG, Bielefeld (DE)

(72) Inventors: Helge STIER, Herford (DE); Andreas KÜHN, Paderborn (DE); Daniel GUSTORFF, Bielefeld (DE)

(21) Appl. No.: 17/760,870

(22) PCT Filed: Sep. 2, 2020
(86) PCT No.: PCT/EP2020/074454

§ 371 Date: Mar. 16, 2022

(30) Foreign Application Priority Data
Sep. 18, 2019 (DE) 10 2019 125 087.0

(51) Int. Cl. E05F 15/40

(52) U.S. Cl. CPC E05F 15/40; E05Y 2400/612; E05Y 2400/664; E05Y 2400/654; E05Y 2600/45; E05Y 2900/148

(57) ABSTRACT

A device for identifying and monitoring the state of an arrangement to be monitored having an openable and closable wing element is provided. The device has a housing, which has a housing base securable on or connected in one piece to the arrangement and a second housing part attachable to and removable from the housing base. The device is also provided with an identification marker, the housing base has a first identification marker for the arrangement to be monitored having an openable and closable wing element, and the second housing part has at least one second identification marker identifying the second housing part.

### BACKGROUND AND SUMMARY OF THE INVENTION

Exemplary embodiments of the invention relate to a device for identifying and monitoring the state of an arrangement to be monitored having an openable and closable wing element, wherein the device comprises a housing having a housing base which is attachable or integrally connected to the arrangement having an openable and closable wing element, and one second housing part attachable to and detachable from the housing base, wherein the device is further provided with an identification marker. Exemplary embodiments of the invention further relate to a corresponding method.

It is known to monitor arrangements “remotely” via a wired connection or via a wireless data connection, in particular with a computer system set up remotely from the sensor device, wherein the transmitted data is evaluated at the computer system. For example, it is known to attach sensors to bridges for status monitoring and to embed them in an IoT (Internet of Things) system in order to perform “structural health monitoring”. Structural Health Monitoring (SHM) is understood to be the continuous or periodic and automated method for determining and monitoring the state of a monitoring object within status monitoring (according to DIN ISO 17359). This is carried out by measurements with permanently installed or integrated transducers and by analysis of the measured data. In this way, damage, for example cracks or deformation, is to be detected at an early stage so that countermeasures can be initiated.

An SHM system for status monitoring of essentially static components consists of the monitoring device with the sensor system and, optionally, signal adaptation units and data storage devices as well as a data transmission device and a data processing system and a usually automated diagnostic system.

It is also conceivable to perform an initial data evaluation directly at the monitoring device—hereinafter also referred to as the device for short. However, this is avoided if possible due to the associated energy consumption.

In EP 3 306 023 A1, this idea, which is known in itself, is taken up and it is proposed to carry out status monitoring of this type on arrangements of the generic type. However, the system envisaged in EP 3 306 023 A1 is kept at a rather theoretically abstract level and has not been brought to application maturity in a way that is advantageous for use in practice.

Against this background, exemplary embodiments of the present invention are directed to a device for the identification and status monitoring of the arrangement to be monitored having an openable and closable wing element, which can be well maintained and which enables safe monitoring. Exemplary embodiments of the invention are also directed to a method with which a safe monitoring of the arrangement is made possible. In addition, an advantageous arrangement is to be created on which the devices are arranged in a particularly advantageous manner.

There is provided a device for identification and status monitoring of an arrangement to be monitored having an openable and closable wing element, wherein the device comprises a housing having a housing base which is attachable or integrally connected to the arrangement having an openable and closable wing element, and at least one second housing part (or at least one secondary part and further—i.e., third and fourth etc.—housing parts) which is attachable to and detachable from the housing base, wherein the device is further provided with an identification marker comprising several components, wherein the housing base comprises a first identification marker which is an identification marker of the arrangement to be monitored having an openable and closable wing element, and wherein the second housing part has at least one second identification marker—optionally also a plurality of further identification markers—which identifies the second housing part or the arrangement to be monitored itself.

The housing base thus comprises the first identification marker, which is designed as an identification marker of the arrangement to be monitored having an openable and closable wing element. This can be applied to the arrangement to be monitored having an openable and closable wing element right when the arrangement to be monitored having an openable and closable wing element is manufactured. In a computer system for receiving, storing, and evaluating data transmitted by the device for identification and status monitoring of an arrangement to be monitored having an openable and closable wing element, a kind of digital twin of the arrangement can be generated and stored for the first identification marker. This digital twin can be specified to different extents. In a simple case, for example, the digital twin may contain a parts list of the arrangement to be monitored having an openable and closable wing element. However, it can also contain further parameters and data about the arrangement to be monitored having an openable and closable wing element.

The arrangement can be, for example, a window or a door of a building. However, the arrangement can also be, for example, a vehicle with a sliding window. In this case, the window is the wing element and the vehicle part that receives the window forms the remaining part of the arrangement. The term wing element generally stands for a movable closure element that is designed to be moved relative to an abutment of the arrangement in order to close and release an opening, for example in a window frame as abutment.

The arrangement to be monitored having an openable and closable wing element is set up at a place of use or installed in an environment such as a building or a vehicle. Now or already before it is advantageous that on the housing base or to the housing base a second housing part can be attached, which itself has a second identification marker.

The computer system for receiving, storing, and evaluating data transmitted by the device for identification and status monitoring of an arrangement to be monitored having an openable and closable wing element must then be informed of the first and the second identification marker so that the computer system can link these two identification markers with one another or in such a way that it can assign data transmitted in the future by the second housing part to the respective arrangement having an openable and closable wing element or to the digital twin of the arrangement having an openable and closable wing element, which can also have the respective first identification marker. This may be carried out in an automated manner. Thus, the second housing part can be designed to read out the first identification marker and to transfer it together with its own second identification marker to a computer to be evaluated.

It may also be provided that when the second housing part is mounted, the two identification markers are detected by a fitter and transmitted to the computer system for receiving, storing, and evaluating data, where they are linked together. In the future, it will then be sufficient for the device to transmit the second identification marker IK-Z with a data sequence of sensor data in order to be able to unambiguously assign the device to a specific arrangement to be monitored having an openable and closable wing element.

However, it can also be advantageously provided, for example, that when the second housing part is fitted, its second identification marker is transmitted by radio to a central computer (e.g., in the cloud), that this then sends a request to a fitter as to which first identification marker this second identification marker belongs to, and that the fitter then sends the corresponding information back to the central computer so that the latter can link the second identification marker to the first identification marker. In the future, it will then again be sufficient for the device to transmit the second identification marker IK-Z with a data sequence of sensor data in order to be able to unambiguously assign the device to a specific arrangement to be monitored.

It may also be provided that directly at an input device, by hand, the second identification marker is assigned to a first one, e.g., at an input mask of a computer, and that then these data are stored and used for monitoring in the future.

In this way, safe process control is ensured in each case so that the receiver (to be explained) can reliably and unambiguously recognize messages/responses/requests from the respective device. Nevertheless, it is possible to maintain or change parts of the electronics by removing the second housing part, e.g., an optional battery or a sensor or a data transmission device, depending on the design. Safe process control remains assured and data acquisition can continue after the end of the maintenance work for the already existing first identification marker. Preferably, after a complete replacement of the second housing part with a replacement second housing part—which has its own, new second identification marker, its new second identification marker can be newly linked in the computer system to the first identification marker of the arrangement having an openable and closable wing element, which has not changed due to the replacement of the second housing part.

The housing is thus at least in two parts. The housing base with the identification marker is so called because it is preferably non-detachably fixed to the arrangement to be monitored having an openable and closable wing element in such a way that it cannot be removed without destroying the first identification marker. The housing base may also be integrally formed with a housing or other component of the arrangement to be monitored having an openable and closable wing element. In this case, the second housing part is attached directly to the arrangement to be monitored having an openable and closable wing element, which can have a type of mounting base or attachment contours of a suitable type for this purpose.

However, the housing base does not have to be arranged completely “under” the second housing part, but can also be arranged partially next to it. Preferably, only one second housing part is provided. However, other housing elements or parts can also be provided that do not have to (but can) have identification markers, but other functional elements such as a battery. The second housing part may itself also be divided into several housing sections, which may be mounted individually or together on the housing base.

It can be further preferably provided that the housing base can be fixed to the arrangement having an openable and closable wing element with a connecting device in such a way that it cannot be removed non-destructively from the arrangement having an openable and closable wing element without the first identification marker becoming unusable, for example being destroyed or detached, so that the housing base no longer has a first identification marker. This ensures that there is always a unique assignment of the identification marker to the arrangement having an openable and closable wing element, which cannot be changed/manipulated.

Then, according to a further advantageous design, it can be provided that the second housing part is detachably fixed to the housing base or the arrangement having an openable and closable wing element, wherein, however, the second identification marker preferably becomes unusable when the second housing part is detached, i.e., is destroyed or breaks away from the second housing part, for example, so that the second housing part no longer comprises it, so that it can no longer be used in this respect. In this way, it can be ensured that the second housing part is always replaced during maintenance work, e.g., to ensure replacement of an energy storage device or replacement of sensors that are to be replaced after a certain period of use. Otherwise, the second identification marker would not be transmitted from the device to the computer system when data is sent in the future.

Exemplary embodiments of the invention also solve the given problem by an arrangement having at least one openable and closable wing element and having at least one device described above.

Advantageously, it can be provided that the arrangement is formed as a window or as a door and comprises a fixed frame and a wing frame. According to a particularly advantageous variant, it can then be further provided that a rebate space is formed between the fixed frame and the wing frame and that the device is accommodated entirely or substantially entirely in the rebate space. This is because it can be accommodated here in a well-protected manner and yet does not interfere, or does not significantly interfere, with the visual impression of the arrangement. The window or door may be, for example, a window or door of a building. The term window also includes the concept of the flap.

It is particularly preferable if the housing of the device is mounted or formed on the wing frame. Thus, it can be provided that the housing of the device or, in particular, its housing base is non-detachably mounted on a groove of the wing frame or the fixed frame. In this way, the mounting of the housing base on the arrangement to be monitored is significantly simplified.

It can further be advantageously provided that a functional element such as a sensor and/or an antenna of the device protrudes into or through a gap that connects the rebate space with one of the spaces adjacent to the window or door—i.e., for example, a building interior or the surroundings of the building. This is because signals can be sensed particularly well here (e.g., opening and closing signals caused by the wing at a sensor) and/or sent to an external receiver. Optionally, a seal can also be arranged in the gap or it can protrude into the gap, in which case the seal (e.g., a stop seal) can in any case lie partially next to the functional element.

According to a further advantageous variant, it can be provided that—with reference to an installation situation in a wall opening of a building—the device is arranged in the region of the rebate space that lies above the center of the installed wing frame and the installed fixed frame, i.e., preferably between an upper horizontal wing frame section and an upper horizontal fixed frame section or between an upper part of the vertical fixed frame and wing frame sections. This is because the device is easily accessible here and yet hardly visible from the outside.

According to embodiments of the invention, a system for status monitoring, comprising at least several arrangements to be monitored is provided, wherein at least a part of the arrangements is provided with at least one openable and closable wing element, wherein a device for identification and status monitoring of the arrangement to be monitored having an openable and closable wing element is associated with a part or each of the arrangements having an openable and closable wing element, wherein the system further comprises: at least one receiver, at least one receiver for receiving and evaluating and/or storing data of the devices, such as in one or more databases, in particular in a data cloud, and at least one computer with an evaluation program for analyzing the data, which is preferably designed to compare and/or store the data with pre-stored parameters and which is designed to assign the transmitted data to a corresponding digital twin of the arrangement having an openable and closable wing element on the basis of transmitted or entered identification identifiers.

It may also be provided that the system further comprises at least one further device for identifying and monitoring the state of an arrangement to be monitored, which device does not have an openable wing element.

Finally, the invention also provides a method for operating a system for status monitoring is provided with at least a plurality of arrangements to be monitored, wherein at least a part of the devices is provided with at least one openable and closable wing element, wherein a part or each of the arrangements having an openable and closable wing element is associated with a device (1) for identification and status monitoring of the arrangement to be monitored having an openable and closable wing element, wherein the system further comprises at least one receiver, at least one receiver (E) for receiving and evaluating and/or storing data from the devices (1), for example in one or more databases, in particular in a data cloud (C), and having at least one computer with an evaluation program for analyzing the data, wherein the method runs on the computer and wherein the method is designed at least to compare and/or store the data with pre-stored parameters and is further designed to assign transmitted data relating to at least the first and the second identification marker to a corresponding digital twin of the arrangement, in particular having an openable and closable wing element.

### BRIEF DESCRIPTION OF THE DRAWING FIGURES

In the following, the invention is described in more detail by means of exemplary embodiments with reference to the drawing, wherein further advantages and options are also illustrated. The invention is not limited to the illustrated exemplary embodiments, but can also be implemented in other ways than shown, as well as in ways equivalent thereto, wherein:

FIG. 1 shows a device designed as a window, which has an openable and closable wing element, wherein a device for identification and status monitoring is/are drawn in dashed lines at two possible installation locations;

FIG. 2 shows in a) a perspective view of the device for identification and status monitoring and a sectional view of the arrangement to be monitored having an openable and closable wing element, and in b) a perspective view of an opened housing of the device for identification and status monitoring and in c) a side view of the housing;

FIG. 3 shows in a) a section through a frame area of a device designed as a window, having a device for identification and status monitoring; in b) and c) each a section enlargement from a), wherein additional details have been drawn in;

FIG. 4 shows a schematic representation of a possible embedding of a device for identification and status monitoring in a higher-level data processing system.

### DETAILED DESCRIPTION

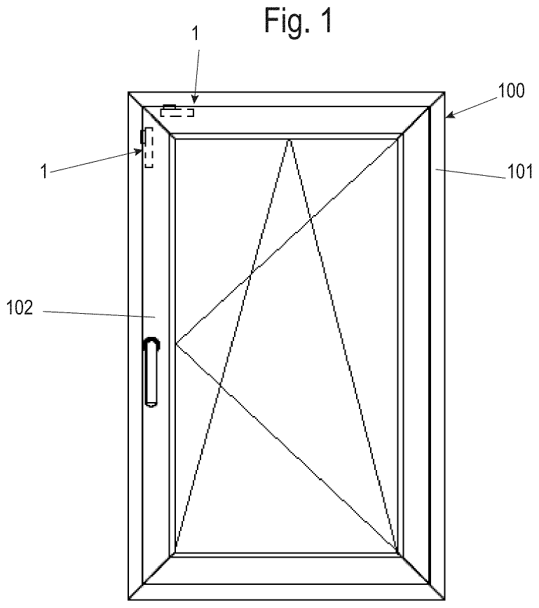

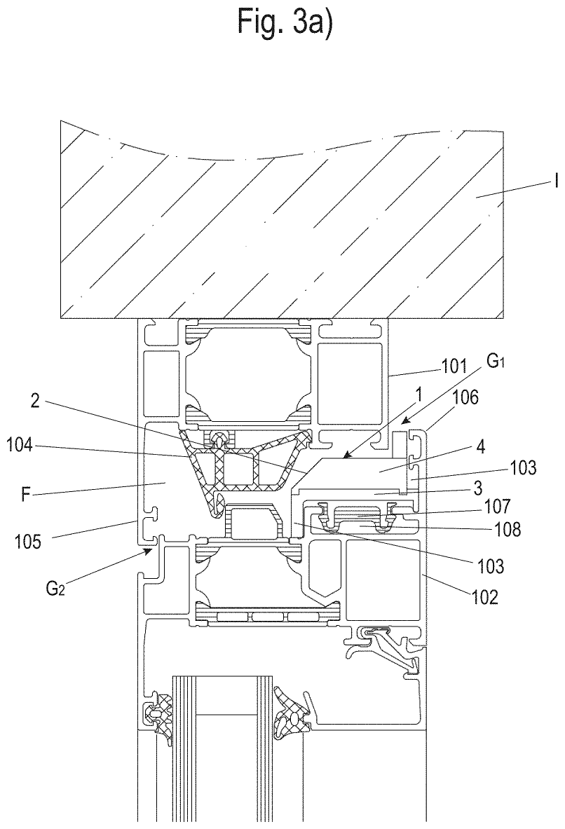

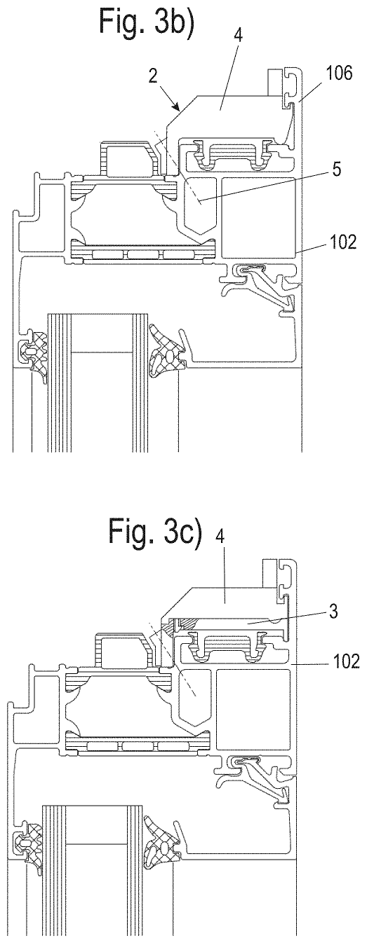

FIG. 1 shows in a) and b) a schematically illustrated arrangement 100 to be monitored, in this case with a fixed frame 101 and an openable and closable wing element 102. The device is designed as a window of a building I (see also FIG. 3a), which has a wall opening into which the fixed frame 101 is inserted. However, the device may alternatively be formed as a door or a flap of a building.

In this context, the fixed frame 101 and/or the wing frame 102 can be constructed in a wide variety of ways. For example, according to one variant, they can be made as a composite frame from one or more metal profiles. Alternatively, they can also be made essentially of a single material, such as plastic or wood.

Preferably, a circumferential rebate space F is formed between the fixed frame 101 and the wing frame 102.

A device 1 for identification and status monitoring is fixed to the arrangement 100 having an openable and closable wing element 102, which has a housing 2.

The housing 2 is preferably arranged on the fixed frame 101. It is further advantageous if the housing 2 is arranged entirely or substantially in the circumferential rebate space F between the fixed frame 101 and the wing frame 102. What is particularly advantageous about this is that the device can be easily accommodated and mounted there and is also well protected (at least when the wing is closed). This is because the housing 1 can advantageously be designed in such a way—for example, elongated and relatively flat—that it can be well accommodated by the rebate space F. It can optionally be further advantageously provided that the housing 2 lies laterally to a center seal 104 (see FIG. 3a).

The housing 1 can be accommodated either on the wing frame 102 or on the fixed frame 101. According to FIG. 3, accommodation on the wing frame 102 was selected. In each case, it is advantageous that fastening contours such as grooves 103 (see, for example, the two grooves in FIG. 3) and/or anchoring elements such as a web 105 or the like are generally present (anyway) in the rebate space F on the fixed frame 101 or on the wing frame 102, which are otherwise used, for example, for fittings or the like, on which the housing 1 can be mounted. This is particularly simple and secure.

Finally, it may also be provided that the housing 2 is thus mounted above a fitting groove 103 and does not engage therein or does not engage therein to any appreciable extent, so that a functional element 108—for example a locking bar—can still be mounted or is mounted below the housing in the fitting groove 107 and remains functional.

It is further advantageous if—in relation to an installation situation in a wall opening of a building—the device is arranged in the area of the rebate space F lying above the center of the installed wing frame 102 and the installed fixed frame 101, i.e., preferably between an upper horizontal wing frame section and an upper horizontal fixed frame section or between an upper part of the vertical fixed frame and wing frame sections. Here, again, the device is barely visible and yet well protected in a simple manner that can be easily accommodated. In addition, maintenance and installation work can usually be carried out particularly well in these areas.

The rebate space F between the fixed frame 101 and the wing frame 102 has two gaps G1; G2 connecting it to the two spaces adjacent to the device—the door or the window.

As a rule, in the area of this gap G1, G2, a web 105 or 106 overlaps the respective other element—i.e., the wing frame 102 or the fixed frame 101.

It is advantageous if a functional element of the device 1—for example a sensor device and/or an antenna—indicated by the reference sign 13—projects into that gap Cl, which is located towards the outside of the building or towards the surroundings. For in this way it is particularly easy to transmit data and other information to a receiver E (discussed in more detail below).

Against this background, the structure of the housing 2 will now be described in more detail.

The housing 2 has a housing base 3 fixed to the arrangement having an openable and closable wing element 102, and at least one second housing part 4 removable from the housing base 3.

It is provided that the housing base 3 is provided with a first identification marker IK-E. The second housing part 4 is also provided with at least one second identification marker IK-Z. These are assigned uniquely in each case and preferably cannot be removed from the housing base 4 or the second housing part without causing damage.

It is then particularly advantageous that the housing base 3 of the device 1 for identification and status monitoring is fixed to the arrangement having an openable and closable wing element 102 with an arrangement 100 having an openable and closable wing element, in particular a fastening means 5, in such a way that it cannot be removed in a destruction-free manner from this arrangement having an openable and closable wing element 102 without destroying the first identification marker.

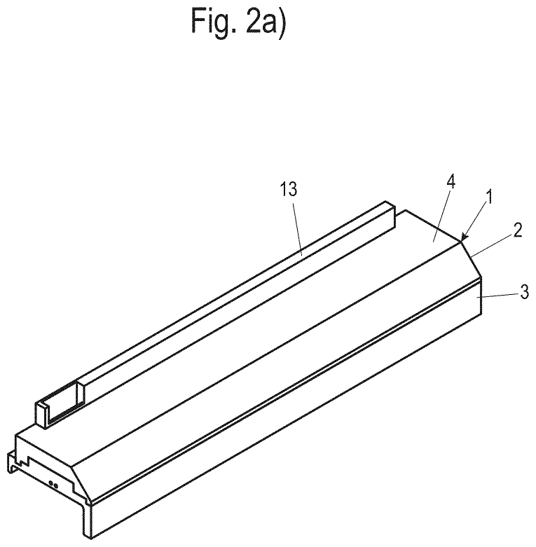

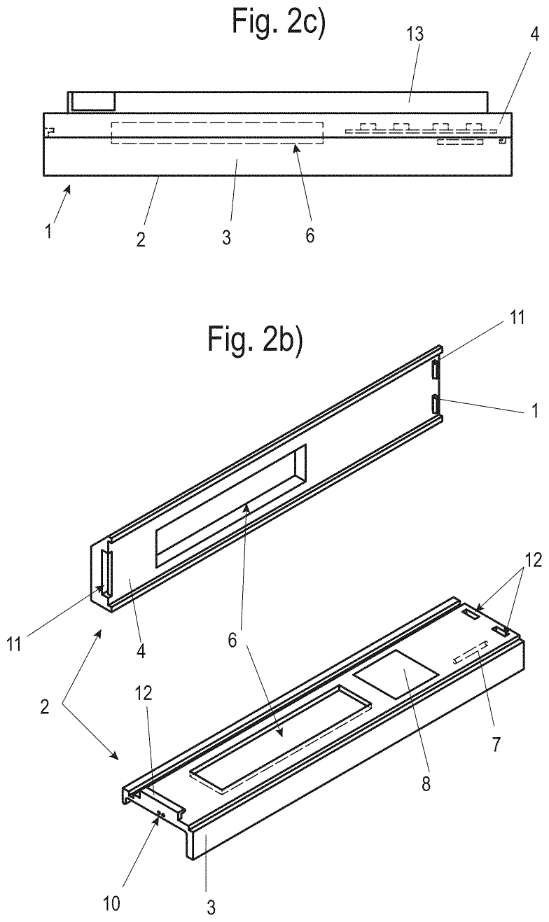

In this way, reliable process control is ensured so that the receiver (to be explained) can reliably and unambiguously recognize messages/responses/requests from the respective device 1. In order to firmly connect the housing base 3 to the arrangement having an openable and closable wing element, a wide variety of connecting means or fastening means 5 can be used. The type of fastening here depends on the nature of the arrangement having an openable and closable wing element 102. Examples of connecting means are turn-off screws, one-time rivets, or micro-cutting blades (which hook into the profile) or also adhesive connections of various kinds. This is indicated in FIGS. 2b and 2c, where dashed lines extend through the housing base 3 and the wing frame 102, representing corresponding fastening means of the type mentioned. Preferably, a pre-latching of the housing 2 or of the housing base 3 to the window or, in this case, to the wing frame 102 is possible beforehand by providing latching means on the housing base 3 which cooperate with corresponding latching means on the window, in particular on the wing frame 102. The corresponding latching means can be undercuts of a groove and the latching means on the housing 2 can be latching webs or the like.

The identification marker IK has the first identification marker of the arrangement to be monitored having an openable and closable wing element and a second identification marker which marks the second housing part and thus the device 1 for identification and status monitoring itself. The identification marker IK-E may, for example, have an NFC or RFID tag 7 as the storage location of the marker, and optionally a QR code 8 for identifying the arrangement having an openable and closable wing element. And the identification marker IK-Z can be designed in essentially any way, such as being stored in an RFID tag 7 or in another non-volatile memory of the electronics of the device.

The second housing part 4 is preferably detachably fixed to the housing base 3. It can thus be detached from the housing base 3, in particular to carry out maintenance work or repairs. It may also be provided that the second housing part needs to be replaced mandatorily. In this case, it is advantageous if it cannot be detached from the housing base without destroying its second identification marker IK-Z (rendering it unusable).

It may further be provided that the second housing part 4 comprises such arrangements that are to be replaced and/or maintained occasionally, such as a battery for supplying power to the device 1. For this purpose, it may further be provided that the housing base 3 and the second housing part 4 together form a receiving space—for example a battery compartment 6—for receiving the battery or the like in order to supply the device 1 itself with electrical power.

Power can also be supplied in other ways or supplementary in other ways, for example via a device for energy harvesting or via a power supply cable that is connected to an external energy storage device or an energy network. In the latter case, it is advantageous if an interface, for example a plug-in connection 10, is provided on the housing for connecting a cable/plug, for example a magnetic plug. In this way, an optional possibility for voltage supply is created by an integrated line transition.

An electronic circuit 9 can optionally be arranged on the second housing part 4 or on the housing base 3, preferably it is formed on the second housing part.

The electronic circuit 9 preferably comprises a data transmission device. This preferably comprises at least the following: a transmitting and/or receiving module, an antenna and a sensor system, and a microprocessor. This electronic circuit 9 preferably further comprises an antenna. The data transmission device is designed at least for transmitting but preferably also for receiving data.

Data transmission is preferably wireless. A wide variety of data transmission methods can be used, such as WLAN, WIFI, Bluetooth, RFID, LoRa, LPWAN, LoRAWAn, LPN, and low frequency radio. This list includes some particularly advantageous data transmission methods, but is not to be regarded as exhaustive.

The electronic circuit 9 preferably further comprises a sensor system having at least one sensor. It may further comprise a control device.

The sensor system is used with one or more sensors of the transducer type to detect properties, in particular physical or chemical properties (physical e.g., heat quantity, temperature, humidity, pressure, sound field quantities, brightness, acceleration, or chemical) of the arrangement having an openable and closable wing element 102 or on the arrangement having an openable and closable wing element 102, in order to detect the parameters on the arrangement to be monitored having an openable and closable wing element 102 qualitatively or quantitatively as a measured variable. These quantities are detected by means of physical or chemical effects and converted into electrical signals that can be further processed. These signals can then be sent to a receiver E directly or after collecting measured values after a certain time using the data transmission device.

Optionally or alternatively, however, the sensor system can also be used to determine other parameters, in particular environmental parameters such as noise pollution, pollutant loads in the air, particulate matter, air pressure, brightness, etc.

The values determined are pre-processed in the sensor system and temporarily stored in order to be able to transmit as little data as possible.

If the device also has a control device, this can also be used to control actuators and the like, to which the device 1 is then to be connected (wirelessly or also by other means).

The second housing part 4 is detachably connected to the housing base 3, for example rigidly latched. For this purpose, corresponding connecting means, in particular releasable corresponding latching means 11, 12, are provided on the housing base 3 and the second housing part 4. This detachable connection can also be realized by other means, for example by screws and nuts or the like.

With the aid of the sensor system, a wide variety of variables can be detected. For example, movements of the openable and closable wing element 102 can be determined. However, it is also conceivable to determine environmental parameters (such as temperature or humidity) directly at the device.

The at least one second housing part 4 preferably contains the aforementioned battery for supplying power to the electronics, which should enable maintenance-free operation for several years. It may preferably be provided to change the battery without having to change the sensor system. For this purpose, the latter can be accommodated in the housing base 3.

However, it may also be provided that the entire second housing part 4 with the sensor system can or must be replaced independently of the housing base 3.

Subsequently, the electronics in the second housing part (in particular the sensor unit and the electronics in the housing base 3) must be coupled with each other again (thus the first identification code IK-E (from the base 3) and the second identification code IK-Z). This can be done in the computer system.

This offers several advantages. For example, a change of the sensor/sensor unit does not lead to a loss of the collected data of the arrangement having an openable and closable wing element, since the identifying components in the housing base are firmly connected to the arrangement to be monitored having an openable and closable wing element.

Depending on the data transmission module, which can preferably also have a radio module, and depending on the available energy, data transmission can also take place via WLAN, WIFI, Bluetooth, NFC, or LPWAN (Sigfox, NB-IoT, Mioty, LoRaWAN).

The data transmission modules/radio modules and the microprocessor unit of the individual devices 1 may be designed for communication of various kinds.

Thus, it can be provided that they each collect sensor values and transmitted information first and then send them to a receiver only at certain time intervals.

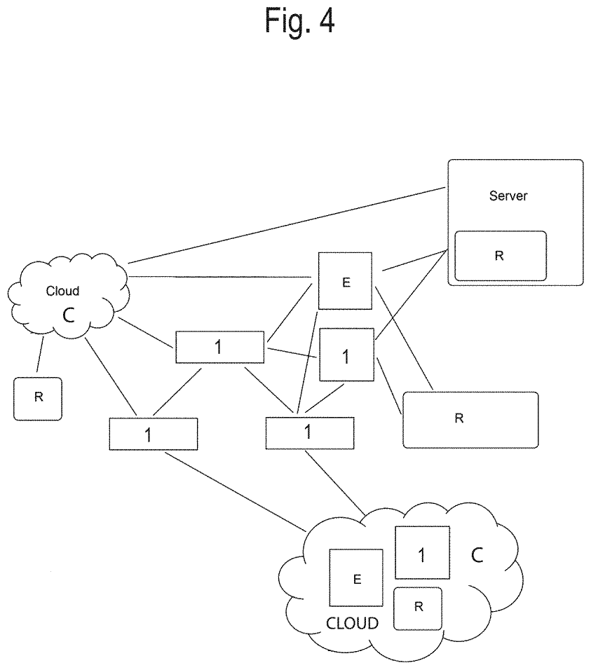

The receiver can also be another device 1 of the same type, which first collects the data from the various devices 1 in, for example, a close environment and then transmits them together at predetermined intervals to a computer, IoT system, or the like, each of which must have a receiver or be connected to one. Such variants are shown in FIG. 4.

It can also be provided that depending on the urgency of a sensor value at the sensor module, it can be decided when a message is sent. For example, a detected intrusion attempt is sent directly, values such as opening cycles or room air parameters are packed into packets and sent together, e.g., once a day or with the next transmission with high urgency.

The data transmission device or the radio module of the respective device 11q is designed at least as a transmitting device for transmitting data, but it can also be designed as a combined transmitting and receiving device for transmitting and receiving data. In the following, the term data transmission device includes both of these options.

A system for monitoring one or more arrangements to be monitored having an openable and closable wing element has one or more, in particular a plurality, of the arrangements to be monitored with openable and closable wing elements 100. In addition, such arrangements may also be arranged on further elements without openable and closable wing elements, for example on fixed glazings, which in this respect may also belong to the system.

In this context, one of the devices 1 for identification and status monitoring is preferably assigned to each of the arrangements to be monitored having an openable and closable wing element 100.

These can, but do not have to be all built the same.

At a receiver E, the data of the devices 1 are received and evaluated and/or stored, such as in one or more databases, in particular in a data cloud C.

In an evaluation program of a computer or computer R, in particular a server, the data can be compared with pre-stored parameters, in particular a digital twin is generated in the data processing system for each arrangement to be monitored having an openable and closable wing element, and the transmitted data are assigned to this digital twin.

The evaluation can include monitoring of various kinds. For example, the transmitted data can be compared with pre-stored setpoints in order to output a signal in the event of a deviation from a setpoint, to indicate that maintenance should be carried out, for example, or to indicate a special case or emergency (for example, a glass breakage or a non-responding actuator or the like).

In FIG. 4, a receiving device E is shown purely schematically. This is at a distance from the arrangements 100 to be monitored, e.g., at a distance from a building provided with the arrangement having an openable and lockable wing element, e.g., centrally in a locality.

The receiving device E can be connected via a further wireless or wired data link—for example an Internet link—to a computer infrastructure and via this or directly to a database—(server R, cloud)—for evaluating and/or storing data or directly form part of the server or the like.

In FIG. 4, connection paths are indicated by arrows. Starting from the devices 1, these are preferably wireless. The connections between the receivers E and the computers can be wireless or wired (including light-conducting connections).

This computer infrastructure with a database can be designed in itself in a largely arbitrary manner, i.e., a computer with data storage designed directly at the receiving device or also as an infrastructure that is available via the Internet, and e.g., contains storage space, computing power and application software in the form of a cloud computing solution. A server of the computer infrastructure can also be formed directly at the receiving device.

The receiving device E is designed at least for receiving and optionally also for transmitting data to the device 1 via the wirelessly designed data link V1. It can also store the data to the computer infrastructure with the database—300.

Data is preferably sent and received in a Low Power Wide Area Network (LPWAN or LPN). According to the online encyclopedia WIKIPEDIA, this comprises a class of network protocols (and devices) for connecting low-energy devices such as battery-powered sensors to a network server. The protocol is designed to achieve long range and low energy consumption of the end devices at low operating cost. This is advantageous, but not mandatory. The data transmission can also be carried out according to another standard. Therefore, depending on the technology of the transmitting unit and the receiving unit and the available energy, the data transmission can also be carried out via WLAN, WIFI, Bluetooth, or NFC. In LPWAN, for example, it takes place via one of the protocols Sigfox, NB-IoT, Mioty, or LoRaWAN.

Overall, this makes it possible to easily and securely link a digital twin, especially in the cloud, with digital parts lists, statuses, and other content by using a unique identification number.

Mechanical information, e.g., forces, accelerations, etc., can be evaluated in order to draw conclusions about the state of the arrangement having an openable and closable wing element.

It is also conceivable to evaluate actuation cycles and/or sensor data, e.g., air temperature and humidity, in order to draw conclusions about the sensor's environment.

This data can be assessed, supplemented, or processed depending on the rights of the user in an application.

The data may also be initially collected locally in the device 1 and transmitted to the server only from time to time to allow the sensor to operate from a battery for several years.

During construction of the arrangement 100—in particular having an openable and closable wing element 102—a parts list of the arrangement 100 is preferably linked to the identification number IK of the element in the server to generate the digital twin.

When the arrangement 100 is installed—in particular having an openable and closable wing element 102—a position of the arrangement having an openable and closable wing element and a confirmation of correct operation are further preferably associated with the identification number of the arrangement having an openable and closable wing element in the server.

During operation of the arrangement having an openable and closable wing element, operating data of the arrangement having an openable and closable wing element is then preferably transmitted to the server and linked to the identification number of the arrangement having an openable and closable wing element.

On the server, the data of the arrangement having an openable and closable wing element can be further analyzed.

In corresponding applications with which a user connects to this server, one or more of the following functionalities can be implemented and used, which means:
the data can be viewed,
possible wear and fault states can be detected,
occlusion states are monitored,
a ventilation recommendation is issued,
an alarm can be triggered,
vandalism can be detected,
a break-in can be detected,
an action can be triggered at an actuator,
maintenance is recommended or planned,
spare parts are ordered, and/or
a message can be sent to a service partner containing all data relevant to the element.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE SIGNS

Device 1
Housing 2
Housing base 3
Second housing part 4
Fastening means 5
Receiving space 6
RFID tag 7
QR code 8
Electronic circuit 9
Plug-in connection 10
Latching means 11, 12
Antenna 13
Arrangement 100
Fixed frame 101
Wing frame 102
Groove 103
Center seal 104
Web 105, 106
Fitting groove 107
Functional element 108
Building I
Rebate space F
Identification marker IK
Receiver E
Computer R
Cloud C
Gap G1, G2

1-28. (canceled)

29. A device for identifying and monitoring a state of an arrangement to be monitored, the arrangement to be monitored having an openable and closable wing element, wherein the device comprises:
a housing, which comprises
a housing base that is fixable to the arrangement or is integrally connected to the arrangement; and
a second housing part attachable to and removable from the housing base and can be removed from the housing base; and
an identification marker, wherein the housing base has a first identification marker that is an identification marker of the arrangement to be monitored having the openable and closable wing element, and the second housing part has at least a second identification marker identifying the second housing part.

30. The device of claim 29, wherein the housing base is fixable to the arrangement having an openable and closable wing element by a connecting device having an openable and closable wing element in such a manner that the housing base cannot be removed in a destruction-free manner from the arrangement having an openable and closable wing element without destroying the first identification marker.

31. The device of claim 29, wherein the second housing part is detachably fixed to the housing base or to the arrangement having an openable and closable wing element.

32. The device of claim 31, wherein after the second housing part is detachably fixed to the housing base or to the arrangement having an openable and closable wing element, when the second housing part is detached, the second identification marker becomes unusable.

33. The device of claim 30, wherein the connecting device is a latching connection, a turn-off screw, a one-time rivet, a micro-cutting blade, or an adhesive connection.

34. The device of claim 29, wherein the first identification marker comprises an NFC tag, RFID tag, or a QR code for identification of the arrangement having an openable and closable wing element.

35. The device of claim 29, wherein the second identification marker comprises an NFC tag, RFID tag, or a QR code for identification of the second housing part.

36. The device of claim 29, wherein the second housing part is configured to transmit the second identification marker by radio.

37. The device of claim 29, further comprising:
a battery receiving space formed by the housing base and the second housing part.

38. The device of claim 29, further comprising:
an arrangement having an openable and closable wing element configured to harvest energy.

39. The device of claim 29, further comprising:
a plug-in connection configured to connection to a magnetic plug.

40. The device of claim 29, further comprising:
an electronic circuit arranged on the second housing part or on the housing base.

41. The device of claim 40, wherein the electronic circuit has a data transmission device.

42. The device of claim 41, wherein the data transmission device is configured for wireless data transmission using WLAN, WIFI, Bluetooth, RFID, LoRa, LPWAN, LoRAWAn, LPN, low frequency, and/or radio.

43. The device of claim 40, wherein the electronic circuit has a sensor system with at least one sensor.

44. The device of claim 29, wherein the second housing part is detachably connected to the housing base via corresponding detachable corresponding latching.

45. An arrangement, comprising:
an openable and closable wing element; and
a device for identifying and monitoring a state of an arrangement to be monitored, the arrangement to be monitored having an openable and closable wing element, wherein the device comprises
a housing, which comprises
a housing base that is fixable to the arrangement or is integrally connected to the arrangement; and
a second housing part attachable to and removable from the housing base and can be removed from the housing base; and
an identification marker, wherein the housing base has a first identification marker that is an identification marker of the arrangement to be monitored having the openable and closable wing element, and the second housing part has at least a second identification marker identifying the second housing part.

46. The arrangement of claim 45, wherein the openable and closable wing element is a window or a door and comprises a fixed frame and a wing frame.

47. The arrangement of claim 46, further comprising:
a rebate space formed between the fixed frame and the wing frame, wherein the device is housed entirely in the rebate space.

48. The arrangement of claim 46, wherein the device is mounted or formed on the wing frame.

49. The arrangement of claim 46, wherein the housing of the device is non-detachably mounted on a groove of the wing frame or the fixed frame.

50. The arrangement of claim 46, wherein the housing of the device is arranged above a functional element in a fitting groove.

51. The arrangement of claim 47, wherein a sensor or an antenna of the device protrudes into or through a gap connecting the rebate space to one of spaces adjacent to the window or door.

52. The arrangement of claim 47, wherein the arrangement is installed in a wall opening of a building, and the device is arranged in the rebate space, which lies above a center of the installed wing frame and the installed fixed frame between an upper horizontal wing frame section and an upper horizontal fixed frame section or between an upper part of the vertical fixed frame and wing frame sections.

53. The arrangement of claim 45, wherein the fixed frame or the wing frame is a composite frame from one or more metal profiles or consists essentially of a single material.

54. A system for status monitoring, comprising:
a plurality of arrangements to be monitored, wherein each of the plurality of arrangements comprises
an openable and closable wing element; and
a device for identifying and monitoring a state of an arrangement to be monitored, the arrangement to be monitored having an openable and closable wing element, wherein the device comprises
a housing, which comprises
a housing base that is fixable to the arrangement or is integrally connected to the arrangement; and
a second housing part attachable to and removable from the housing base and can be removed from the housing base; and
an identification marker, wherein the housing base has a first identification marker that is an identification marker of the arrangement to be monitored having the openable and closable wing element, and the second housing part has at least a second identification marker identifying the second housing part;
at least one receiver configured to receive, evaluate, or store data from the device of each of the plurality of arrangements to be monitored in one or more databases; and
at least one computer executing an evaluation program configured to analyze the data to compare or store the data with pre-stored parameters, wherein the evaluation program is also configured to assign the received data to a corresponding digital twin of one of the plurality of arrangements based on received or entered identification markers.

55. The system of claim 54, further comprising:
at least one further device configured to identify and monitor a state of an arrangement to be monitored, wherein the at least one further device does not have an openable wing element.
